(19) United States
(12) Patent Application Publication
(10) Pub. No.: US 2026/0025714 A1
(43) Pub. Date: Jan. 22, 2026

(54) METHOD AND SYSTEM FOR DYNAMIC NETWORK SLICE RE-BALANCING SERVICE

(71) Applicant: Verizon Patent and Licensing Inc., Basking Ridge, NJ (US)

(72) Inventors: Saikrishnan Sekar, Chennai (IN); Mohanraj Srinivasan, Chennai (IN); Karthika Jeevanandam, Chennai (IN); Anandh Sankaralingam, Chennai (IN)

(21) Appl. No.: 18/779,219

(22) Filed: Jul. 22, 2024

(51) Int. Cl. H04W 28/20; H04L 41/16; H04W 28/08; H04W 72/0453

(52) U.S. Cl. CPC H04W 28/20; H04L 41/16; H04W 28/0983; H04W 72/0453

(57) ABSTRACT

A method, a network device, and a non-transitory computer-readable storage medium are described in relation to a dynamic network slice re-balancing service. The service includes use of an adaptive clustering algorithm, which includes a hyperparameter that has an adjustable value based on the data subject to clustering. The service may include identifying usage patterns based on the clustering of data. The service may also include clustering of radio access devices based on physical resource block (PRB) utilization of a network slice. The service may further include predicting a prospective PRB utilization of the network slice, determining whether a current PRB configuration is to be adjusted, and provisioning the radio access devices with a predicted PRB configuration, which may increase or decrease a PRB allotment.

### BACKGROUND

Development and design of networks present certain challenges from a network-side perspective and an end device perspective. For example, Next Generation (NG) wireless networks, such as Fifth Generation New Radio (5G NR) networks are being deployed and are under development. End devices may connect to a radio access network (RAN) according to several types of configurations. The development of strategies for optimizing the use of network resources are ongoing.

### BRIEF DESCRIPTION OF THE DRAWINGS

FIG. 1 is a diagram illustrating an exemplary environment in which an exemplary embodiment of a dynamic network slice re-balancing service may be implemented;

FIGS. 2A-2C is a diagram illustrating another exemplary environment in which an exemplary embodiment of the dynamic network slice re-balancing service may be implemented;

FIG. 2D is a diagram illustrating an exemplary process of an exemplary embodiment of the dynamic network slice re-balancing service;

FIG. 3 is a diagram illustrating exemplary components of a device that may correspond to one or more of the devices illustrated and described herein;

FIG. 4 is a flow diagram illustrating an exemplary process of an exemplary embodiment of the dynamic network slice re-balancing service; and

FIG. 5 is a flow diagram illustrating another exemplary process of an exemplary embodiment of the dynamic network slice re-balancing service.

### DETAILED DESCRIPTION

The following detailed description refers to the accompanying drawings. The same reference numbers in different drawings may identify the same or similar elements. Also, the following detailed description does not limit the invention.

In 5G network slicing, there can be multiple network slices configured to support different user demands such that each network slice may have its own characteristics. In the radio access network (RAN), the physical resource block (PRB) configuration for each network slice and associated RAN device or node may be an important factor in efficiently managing and utilizing radio resources. For example, a certain number of PRBs may be allocated to each network slice during a given time period. However, it is difficult to estimate the optimal PRB configuration in a manner that ensures the effective utilization of radio spectrum. For example, there are many factors that may impact traffic patterns of a network slice, such as time of day, location/service area, type of users and associated applications (e.g., streamers, gamers, etc.), and so forth.

According to exemplary embodiments, a dynamic network slice re-balancing service is described herein. According to an exemplary embodiment, the dynamic network slice re-balancing service may be implemented by a network device. For example, the network device may be implemented by an access device, a core device, an external device, or a network management device, as described herein. According to other examples, the network device may be implemented by a combination of network devices, such as the access device and the network management device, the core device and the network management device, the access device and the core device, the external device and the access device, and so forth.

According to an exemplary embodiment, the dynamic network slice re-balancing service may include estimating a prospective and optimal PRB configuration based on usage patterns, as described herein. According to an exemplary embodiment, the dynamic network slice re-balancing service may include classifying access devices or nodes based on the usage patterns and an adaptive clustering algorithm, as described herein. For example, the adaptive clustering algorithm may be implemented as an adaptive Balanced Iterative Reducing and Clustering using Hierarchies (BIRCH) clustering algorithm, a K-means clustering algorithm, and/or the like.

According to an exemplary embodiment, the dynamic network slice re-balancing service may include predicting PRB utilization for the classified access devices or nodes using a machine learning and/or an artificial intelligence (ML/AI) model. For example, the model may be implemented as a neural network model (NNM) and/or another type of model (e.g., a Generalized Linear Model (GLM), etc.). According to an exemplary embodiment, the dynamic network slice re-balancing service may use an optimization algorithm, such as a reinforcement learning algorithm or another type of learning algorithm (e.g., supervised learning, etc.). For example, the dynamic network slice re-balancing service may use an enhanced reinforced neural network model to predict the PRB utilization for the classified access devices or nodes and associated network slices, as described herein.

According to an exemplary embodiment, the dynamic network slice re-balancing service may include configuring the predicted PRB utilization dynamically and autonomously in real time for an access device or node associated with a network slice, as described herein. For example, the dynamic network slice re-balancing service may compare the predicted PRB utilization to a current PRB configuration. Based on a result of the comparison, the dynamic network slice re-balancing service may determine that no reconfiguration is needed, or reduce or increase the PRB allocation, as described herein.

According to an exemplary embodiment, when there is a reconfiguration, the dynamic network slice re-balancing service may generate a PRB configuration based on the predicted PRB utilization. The dynamic network slice re-balancing service may include converting the predicted PRB utilization data using a discretization approach, such as mean-binning or another suitable process that may smoothen the PRB values. The dynamic network slice re-balancing service may also provide a notification to network personnel when PRB reserves are below a threshold value.

In view of the foregoing, the dynamic network slice re-balancing service may improve network resource utilization based on optimal PRB configuration estimations. Additionally, the dynamic network slice re-balancing service may improve end device-side access and use of various application services via network slices, as described herein.

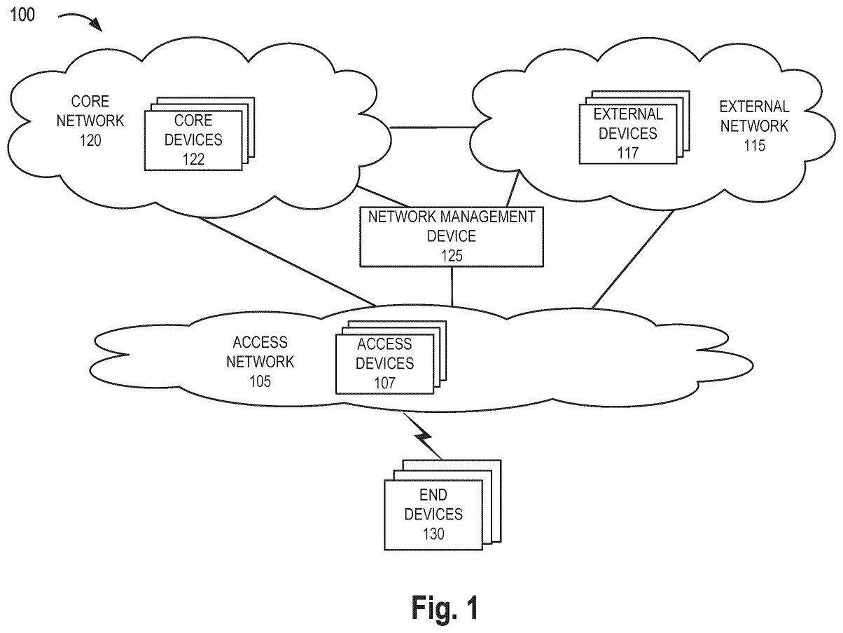

FIG. 1 is a diagram illustrating an exemplary environment 100 in which an exemplary embodiment of a dynamic network slice re-balancing service may be implemented. As illustrated, environment 100 includes an access network 105, an external network 115, and a core network 120. Access network 105 includes access devices 107 (also referred to individually or generally as access device 107). External network 115 includes external devices 117 (also referred to individually or generally as external device 117). Core network 120 includes core devices 122 (also referred to individually or generally as core device 122). Environment 100 further includes a network management device 125 and end devices 130 (also referred to individually or generally as end device 130).

The number, type, and arrangement of networks illustrated in environment 100 are exemplary. For example, according to other exemplary embodiments, environment 100 may include fewer networks, additional networks, and/or different networks. For example, according to other exemplary embodiments, other networks not illustrated in FIG. 1 may be included, such as an X-haul network (e.g., backhaul, mid-haul, fronthaul, etc.), a transport network, or another type of network that may support a wireless service and/or an end device application service, as described herein.

A network device, a network element, or a network function (referred to herein simply as a network device) may be implemented according to one or multiple network architectures, such as a client device, a server device, a peer device, a proxy device, a cloud device, and/or a virtualized network device. Additionally, a network device may be implemented according to various computing architectures, such as centralized, distributed, cloud (e.g., elastic, public, private, etc.), edge, fog, and/or another type of computing architecture, and may be incorporated into distinct types of network architectures (e.g., Software Defined Networking (SDN), client/server, peer-to-peer, etc.) and/or implemented with various networking approaches (e.g., logical, virtualization, network slicing, etc.). The number, the type, and the arrangement of network devices are exemplary.

Environment 100 includes communication links between the networks and between the network devices. Environment 100 may be implemented to include wired, optical, and/or wireless communication links. A communicative connection via a communication link may be direct or indirect. For example, an indirect communicative connection may involve an intermediary device and/or an intermediary network not illustrated in FIG. 1. A direct communicative connection may not involve an intermediary device and/or an intermediary network. The number, type, and arrangement of communication links illustrated in environment 100 are exemplary.

Environment 100 may include various planes of communication including, for example, a control plane (CP), a user plane (UP), a service plane, and a network management plane, or a sub-combination thereof. Environment 100 may include other types of planes of communication. A message communicated in support of the dynamic network slice re-balancing service may use at least one of these planes of communication.

According to various exemplary implementations, the interface of the network device may be a service-based interface, a reference point-based interface, an Open Radio Access Network (O-RAN) interface, a 5G interface, another generation of interface (e.g., 5.5G, Sixth Generation (6G), Seventh Generation (7G), etc.), or some other type of network interface (e.g., proprietary, etc.).

Access network 105 may include one or multiple networks of one or multiple types and technologies. For example, access network 105 may be implemented to include a Fifth Generation (5G) RAN, a future generation RAN (e.g., a Sixth Generation (6G) RAN, a Seventh Generation (7G) RAN, etc.), a centralized-RAN (C-RAN), an Open-RAN (O-RAN), and/or another type of access network. Access network 105 may include a legacy RAN (e.g., a Fourth Generation (4G) RAN, etc.). Access network 105 may communicate with and/or include other types of access networks, such as, for example, a Wi-Fi network, a local area network (LAN), a Citizens Broadband Radio System (CBRS) network, a cloud RAN, a virtualized RAN (vRAN), a self-organizing network (SON), a wired network (e.g., optical, cable, etc.), or another type of network that provides access to or can be used as an on-ramp to access network 105 and/or core network 120.

Access network 105 may include different and multiple functional splitting, such as options 1, 2, 3, 4, 5, 6, 7, or 8 that relate to combinations of access network 105 and core network 120 including an Evolved Packet Core (EPC) network and/or a Next Generation Core (NGC)/5G core network, or the splitting of the various layers (e.g., physical layer, media access control (MAC) layer, radio link control (RLC) layer, and packet data convergence protocol (PDCP) layer, etc.), plane splitting (e.g., user plane, control plane, etc.), interface splitting (e.g., F1-U, F1-C, E1, Xn-C, Xn-U, X2-C, Common Public Radio Interface (CPRI), etc.) as well as other types of network services, such as dual connectivity (DC) or higher (e.g., a secondary cell group (SCG) split bearer service, a master cell group (MCG) split bearer, an SCG bearer service, non-standalone (NSA), standalone (SA), etc.), carrier aggregation (CA) (e.g., intra-band, inter-band, contiguous, non-contiguous, etc.), edge and core network slicing, coordinated multipoint (CoMP), various duplex schemes (e.g., frequency division duplex (FDD), time division duplex (TDD), half-duplex FDD (H-FDD), etc.), and/or another type of connectivity service (e.g., NSA new radio (NR), SA NR, etc.).

According to some exemplary embodiments, access network 105 may be implemented to include various architectures of wireless service, such as, for example, macrocell, microcell, femtocell, picocell, metrocell, NR cell, Long Term Evolution (LTE) cell, non-cell, or another type of wireless architecture. Additionally, according to various exemplary embodiments, access network 105 may be implemented according to various wireless technologies (e.g., RATs, etc.), and various wireless standards, frequencies, bands, and segments of radio spectrum (e.g., centimeter (cm) wave, millimeter (mm) wave, below 6 gigahertz (GHz), above 6 GHz, higher than mm wave, C-band, licensed radio spectrum, unlicensed radio spectrum, above mm wave), and/or other attributes or technologies used for radio communication. Additionally, or alternatively, according to some exemplary embodiments, access network 105 may be implemented to include various wired and/or optical architectures for wired and/or optical access services.

Depending on the implementation, access network 105 may include one or multiple types of network devices, such as access devices 107. For example, access device 107 may include a next generation Node B (gNB), an enhanced LTE (eLTE) evolved Node B (eNB), an eNB, a radio network controller (RNC), a radio intelligent controller (RIC), a base station controller (BSC), a remote radio head (RRH), a baseband unit (BBU), a radio unit (RU), a remote radio unit (RRU), a centralized unit (CU), a CU-control plane (CP), a CU-user plane (UP), a distributed unit (DU), a small cell node (e.g., a picocell device, a femtocell device, a microcell device, a home eNB, a home gNB, etc.), an open network device (e.g., O-RAN Centralized Unit (O-CU), O-RAN Distributed Unit (O-DU), O-RAN next generation Node B (O-gNB), O-RAN evolved Node B (O-eNB)), a 5G ultra-wide band (UWB) node, a future generation wireless access device (e.g., a 6G wireless station, a 7G wireless station, or another generation of wireless station), a transport device (e.g., a router or similar network device that may support a transport layer protocol (e.g., user datagram protocol (UDP), transmission control protocol (TCP), QUIC, Real-time Transport Protocol (RTP), etc.), and/or some sub-combination such access devices 107.

Access device 107 may include other types of wireless access devices, such as a Wi-Fi device, a hotspot device, and/or a fixed wireless access customer premise equipment (FWA CPE), etc.) that provides a wireless access service. Additionally, access devices 107 may include a wired and/or an optical device (e.g., modem, wired access point, optical access point, Ethernet device, multiplexer, etc.) that provides network access and/or transport service.

According to some exemplary implementations, access device 107 may include a combined functionality of multiple RATs (e.g., 4G and 5G functionality, 5G and 5.5G functionality, 5G and 6G), etc.) via soft and hard bonding based on demands and needs. According to some exemplary implementations, access device 107 may include a split access device (e.g., a CU-control plane (CP), a CU-user plane (UP), etc.) or an integrated functionality, such as a CU-CP and a CU-UP, or other integrations of split RAN nodes. Access device 107 may be an indoor device or an outdoor device.

According to various exemplary implementations, access device 107 may include one or multiple sectors or antennas. The antenna may be implemented according to various configurations, such as single input single output (SISO), single input multiple output (SIMO), multiple input single output (MISO), multiple input multiple output (MIMO), massive MIMO, three dimensional (3D) and adaptive beamforming (also known as full-dimensional agile MIMO), two dimensional (2D) beamforming, antenna spacing, tilt (relative to the ground), radiation pattern, directivity, elevation, planar arrays, and so forth. Depending on the implementation, access device 107 may provide a wireless access service at a cell, a sector, a sub-sector/zone, carrier, and/or other configurable level. For example, the sub-sector/zone level may include multiple divisions of a geographic area of a sector relative to access device 107. By way of further example, the sector may be divided based on proximity to the antenna of access device 107 (e.g., near, mid, far) and/or another criterion. According to another example, radio coverage of a location may be divided based on a Military Grid Reference System (MGRS) or another type of grid system to produce geo-bins. The size and/or shape of each geo-bin may be configurable. The size and/or the shape of a geo-bin may depend on the types of access device 107 (e.g., small cell device versus gNB, etc.), attributes of access device 107 (e.g., antenna configuration, radio frequency band of beam, etc.), and/or other factors (e.g., terrain of the radio covered locale).

According to an exemplary embodiment, at least some of access devices 107 include logic of the dynamic network slice re-balancing service, as described herein. For example, at least some of access devices 107 may transmit and receive messages pertaining to the dynamic network slice re-balancing service, as described herein. For example, access device 107 may provide state information (e.g., resource utilization, congestion, etc.), performance data, configuration data, and other types of data, as described herein, pertaining to access device 107 and other RAN-based network elements (e.g., cell, sector, sub-sector/zone, network slice, radio bearer, QoS flow, PDU session, protocol layer, etc.) to network management device 125. Additionally, for example, access device 107 may be provisioned by network management device 125, as described herein.

External network 115 may include one or multiple networks of one or multiple types and technologies that provide an application service. For example, external network 115 may be implemented using one or multiple technologies including, for example, network function virtualization (NFV), SDN, cloud computing, Infrastructure-as-a-Service (IaaS), Platform-as-a-Service (PaaS), Software-as-a-Service (SaaS), or another type of network technology. External network 115 may be implemented to include a cloud network, a private network, a public network, a multi-access edge computing (MEC) network, a fog network, the Internet, a packet data network (PDN), a service provider network, the World Wide Web (WWW), an Internet Protocol Multimedia Subsystem (IMS) network, a Rich Communication Service (RCS) network, a software-defined (SD) network, a virtual network, a packet-switched network, a data center, a data network, or other type of application service layer network that may provide access to and may host an end device application service.

Depending on the implementation, external network 115 may include various network devices such as external devices 117. For example, external devices 117 may include virtual network devices (e.g., virtualized network functions (VNFs), servers, host devices, application functions (AFs), application servers (ASs), server capability servers (SCSs), containers, hypervisors, virtual machines (VMs), pods, network function virtualization infrastructure (NFVI), and/or other types of virtualization elements, layers, hardware resources, operating systems, engines, etc.) that may be associated with application services for use by end devices 130. By way of further example, external devices 117 may include mass storage devices, transport devices, data center devices, NFV devices, SDN devices, cloud computing devices, platforms, and other types of network devices pertaining to various network-related functions (e.g., security, management, charging, billing, authentication, authorization, policy enforcement, development, etc.). Although not illustrated, external network 115 may include one or multiple types of core devices 122, as described herein.

External devices 117 may host one or multiple types of application services. For example, such application services may pertain to broadband services in dense areas (e.g., pervasive video, smart office, operator cloud services, video/photo sharing, etc.), broadband access everywhere (e.g., 50/100 Mbps, ultra-low-cost network, etc.), enhanced mobile broadband (eMBB), higher user mobility (e.g., high speed train, remote computing, moving hot spots, etc.), Internet of Things (e.g., smart wearables, sensors, mobile video surveillance, smart cities, connected home, etc.), extreme real-time communications (e.g., tactile Internet, augmented reality (AR), virtual reality (VR), etc.), lifeline communications (e.g., natural disaster, emergency response, etc.), ultra-reliable communications (e.g., automated traffic control and driving, collaborative robots, health-related services (e.g., monitoring, remote surgery, etc.), drone delivery, public safety, etc.), broadcast-like services, communication services (e.g., email, text (e.g., Short Messaging Service (SMS), Multimedia Messaging Service (MMS), etc.), massive machine-type communications (mMTC), voice, video calling, video conferencing, instant messaging), video streaming, fitness services, navigation services, online gaming, web services, and/or other types of wireless and/or wired application services (e.g., weather-related, traffic-related, etc.). External devices 117 may also include other types of network devices that support the operation of external network 115 and the provisioning of application services, such as an orchestrator, an edge manager, an operations support system (OSS), a local domain name system (DNS), registries, and the like. External devices 117 may include non-virtual, logical, and/or physical network devices.

According to an exemplary embodiment, at least some of external devices 117 include logic of the dynamic network slice re-balancing service, as described herein. For example, at least some external devices 117 may transmit and receive messages pertaining to the dynamic network slice re-balancing service, as described herein. For example, external device 117 may provide state information (e.g., resource utilization, congestion, etc.), performance data, configuration data, and/or other types of data, as described herein, pertaining to external device 117 and/or a network element (e.g., an external network slice, PDU sessions, QoS flows, user plane traffic, etc.).

Core network 120 may include one or multiple networks of one or multiple network types and technologies. Core network 120 may include a complementary network of access network 105. For example, core network 120 may be implemented to include a 5G core network, an EPC of an LTE network, an LTE-Advanced (LTE-A) network, and/or an LTE-A Pro network, a future generation core network (e.g., a 5.5G, a 6G, a 7G, or another generation of core network), and/or another type of core network.

Depending on the implementation of core network 120, core network 120 may include diverse types of network devices that are illustrated in FIG. 1 as core devices 122. For example, core devices 122 may include a user plane function (UPF), a Non-3GPP Interworking Function (N3IWF), an access and mobility management function (AMF), a session management function (SMF), a unified data management (UDM) device, a unified data repository (UDR), an authentication server function (AUSF), a security anchor function (SEAF), a network slice selection function (NSSF), a network repository function (NRF), a policy control function (PCF), a network data analytics function (NWDAF), a network exposure function (NEF), a service capability exposure function (SCEF), a lifecycle management (LCM) device, a mobility management entity (MME), a packet data network gateway (PGW), an enhanced packet data gateway (ePDG), a wireless access gateway (WAG), a tunnel termination gateway (TTG), a serving gateway (SGW), a home agent (HA), a General Packet Radio Service (GPRS) support node (GGSN), a home subscriber server (HSS), an authentication, authorization, and accounting (AAA) server, a policy and charging rules function (PCRF), a policy and charging enforcement function (PCEF), a charging system (CS), a transport device, and/or a future generation core device 122 that may perform a similar function.

According to other exemplary implementations, core devices 122 may include additional, different, and/or fewer network devices than those described. For example, core devices 122 may include a non-standard or a proprietary network device, and/or another type of network device that may be well-known but not particularly mentioned herein. Core devices 122 may also include a network device that provides a multi-RAT functionality (e.g., 4G and 5G, 5G and 6G, 6G and 7G, etc.), such as an SMF with PGW control plane functionality (e.g., SMF+PGW-C), a UPF with PGW user plane functionality (e.g., UPF+PGW-U), and/or other combined nodes (e.g., an HSS with a UDM/UDR, an MME with an AMF, etc.). Also, core devices 122 may include a split core device 122. For example, core devices 122 may include a session management (SM) PCF, an access management (AM) PCF, a user equipment (UE) PCF, and/or another type of split architecture associated with another core device 122, as described herein.

According to an exemplary embodiment, at least some of core devices 122 include logic of the dynamic network slice re-balancing service, as described herein. For example, at least some of core devices 122 may transmit and receive messages pertaining to the dynamic network slice re-balancing service, as described herein. For example, core device 122 may provide state information (e.g., resource utilization, congestion, etc.), performance data, configuration data, and/or other types of data, as described herein, pertaining to core device 122 and/or a network element (e.g., a core network slice, PDU sessions, QoS flows, user plane traffic, etc.).

Network management device 125 may include a network device that includes logic of the dynamic network slice re-balancing service, as described herein. Although network management device 125 is depicted outside of access network 105, external network 115, and core network 120, such an illustration is exemplary. According to other exemplary implementations, network management device 125 may reside in one or multiple networks depicted and described herein. Additionally, network management device 125 may be implemented in a centralized, distributed, and/or another type of network and/or computing architecture as a network device or system, as described herein.

According to an exemplary embodiment, network management device 125 may include a data sub-service of the dynamic network slice re-balancing service, as described herein. According to an exemplary embodiment, the data sub-service may include collecting different types of data from different sources. According to various exemplary implementations, the data obtained may be raw data or processed data. In this regard, according to various exemplary embodiments, the data sub-service may or may not include logic that processes the data, such as formatting data (e.g., transforming raw data into a particular format, etc.), compressing and/or decompressing data, adding data, deleting data, encrypting and/or decrypting data, classifying data, organizing data, and so forth. The data may include date and timestamp information and/or a device identifier that identifies a device (e.g., end device 130, access device 107, external device 117, core device 122) from which the data originates.

According to an exemplary embodiment, the data sub-service may include curating the data into different categories. For example, the categories may include customer-to-network association data and network-to-event association data. The customer-to-network association data may include user profile information. For example, the user profile information may include network slice selection assistance information (NSSAI) of network slices to which a user/end device 130 is subscribed, UE Route Selection Policy (URSP) profile, type of end device and capability information, subscription information, and the like, for example. The customer-to-network association data may include access device 107 and sub-components thereof (e.g., antenna, scheduler, processor, RU, DU, components, etc.) configuration data associated with a network slice and a PRB configuration.

The customer-to-network association data may include performance data. For example, the performance data may include performance metric parameters and values pertaining to key performance indicators (KPIs), Quality of Service (QoS) parameters and values, Quality of Experience (QoE) parameters and values, SLA parameters and values, and/or Mean Opinion Score (MOS) parameters and values. A performance metric value may be implemented as a single value (e.g., X) or a range of values (e.g., X to Y). The performance metric value may also be associated with a time period (e.g., seconds, hour(s), day(s), and/or another time period), may indicate an average value, a mean value, and/or another statistical value. By way of further example, the performance metric data may relate to the performance associated with user sessions, connections, channels, messaging, a network procedure (e.g., attachment, handover, session establishment, local breakout, dual connectivity, etc.), application services, and/or other types of metrics in relation to a network element and/or a geographic area associated with a service. The performance metric data may relate to user plane or user plane and control plane events or metrics. As an example, the performance metric data may include information relating to Radio Resource Control (RRC) setup failures, handover attempts, handover failures, radio bearer drops, uplink and/or downlink throughput, voice call drops, random access failures, data volume (e.g., maximum, minimum, etc.), latency, packet error, delay, bit rates (e.g., guaranteed, maximum, minimum, burst, etc.), jitter, retries, 5G QoS Class Identifiers (QCIs) and characteristics, and so forth.

The customer-to-network association data may include other types of information, such as total number of users connected to each network slice and network resource utilization at access devices 107 and sub-components thereof (e.g., hardware, software, PRBs, etc.) associated with each network slice and PRB configuration.

The network-to-event association data may include network alarm data, data indicating unplanned outages, data indicating radio sites with performance issues, special event data (e.g., date, time, location relating to events, such as a music festival, a sporting event (e.g., football, baseball, basketball, hockey, etc.), a holiday event, and the like), data pertaining to failed detectors for radio sites having capacity and/or performance issues (e.g., users reporting performance issues via a third party service, such as Ookla®), weather and disaster data, and the like. According to other examples, the data sub-service may include additional and/or different categories. According to yet other exemplary embodiments, the data sub-service may omit curating the data into different categories.

According to an exemplary embodiment, network management device 125 may include an adaptive clustering sub-service of the dynamic network slice re-balancing service, as described herein. The adaptive clustering sub-service may include logic of an adaptive clustering algorithm. For example, the adaptive clustering sub-service may include classifying access devices 107 and/or sub-components thereof associated with a network slice and PRB configuration based on the usage patterns, as described herein.

According to an exemplary embodiment, the adaptive clustering algorithm may be implemented as an adaptive BIRCH clustering algorithm or another type of adaptive agglomerative hierarchical clustering algorithm. For example, the adaptive BIRCH clustering algorithm may dynamically adapt parameters (e.g., hyperparameters, etc.) based on varying event intensities identified in the data. This is in contrast to existing clustering methods that apply static parameters that may not effectively capture the nuances and variations induced by external events (e.g., network-to-event association data, as described herein).

According to an exemplary embodiment, the adaptive BIRCH clustering algorithm may analyze and identify varying event intensities included in the data, and may adjust hyperparameters (e.g., the threshold for cluster merging, the number of clusters, the max number of data points in a sub-cluster, etc.) in response to and in correspondence to the intensity of events impacting the dataset. By way of further example, as event intensity increases, the threshold for cluster merging may be reduced so that the adaptive clustering sub-service may be more sensitive to smaller differences between data points and the number of clusters may be increased. In this way, the clustering service may adaptively adjust the differentiation between data, reveal emerging and/or latent patterns, and enable more precise and contextually relevant data segmentation that may significantly improve the utility of clustering while maintaining high performance without manual re-calibration of clustering parameters.

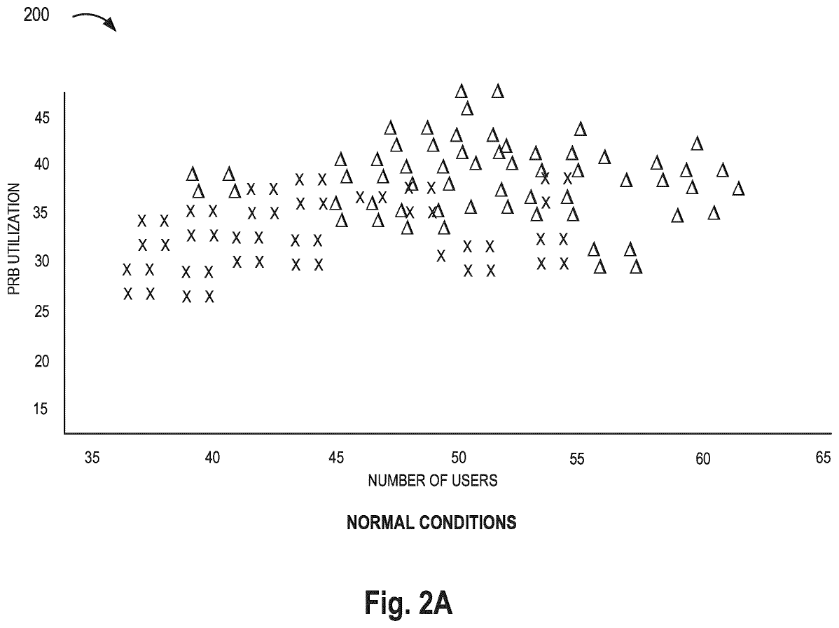

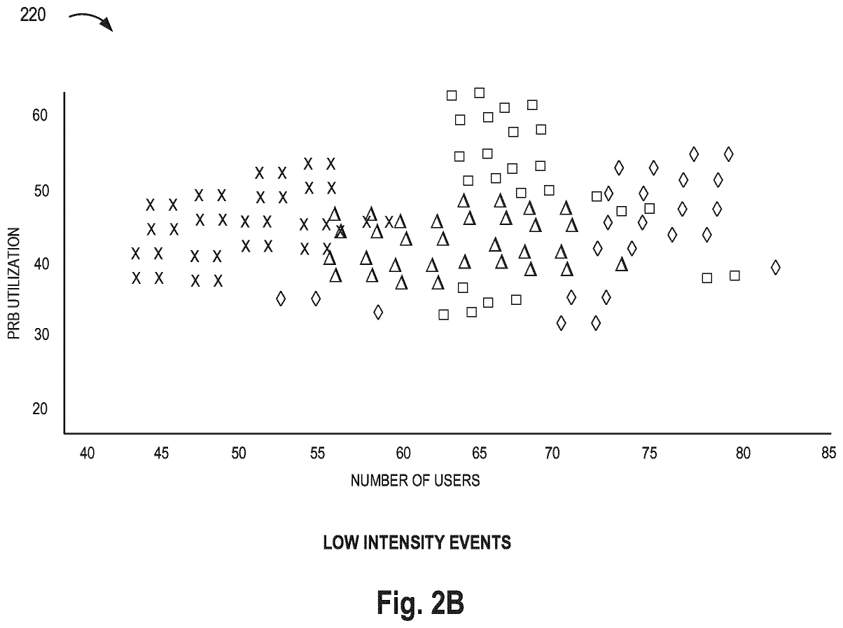

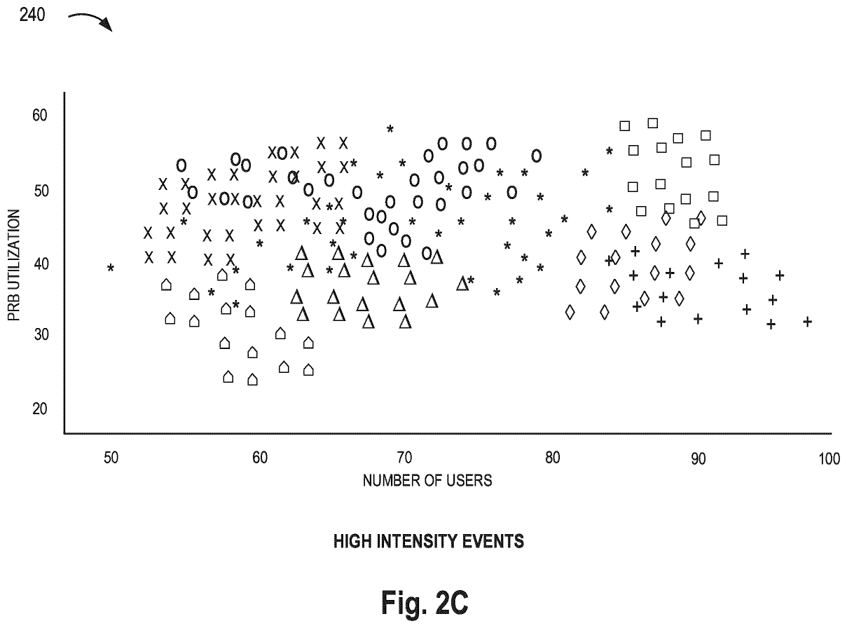

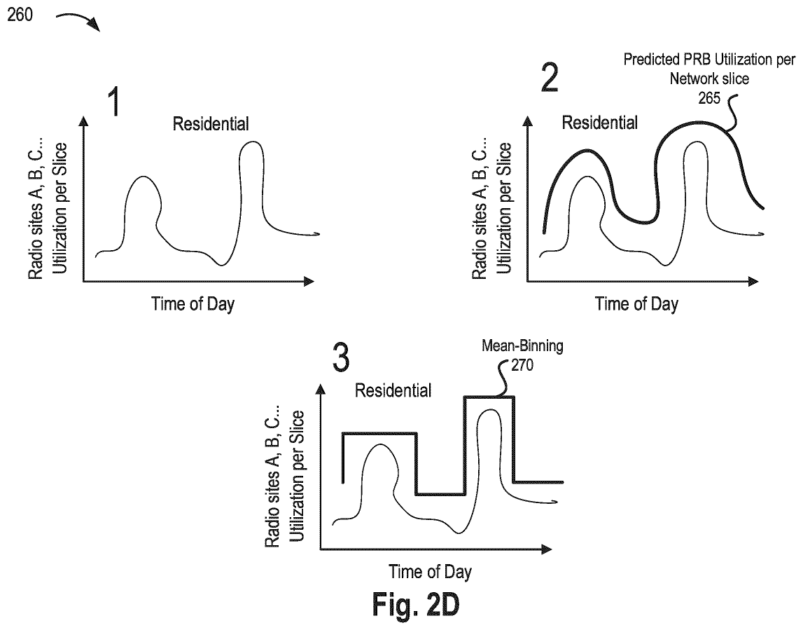

FIGS. 2A-2C are diagrams illustrating exemplary data classified by the adaptive clustering sub-service of the dynamic network slice re-balancing service. As illustrated, FIGS. 2A-2C each illustrates data relating to PRB utilization and number of users/end devices 130. In FIG. 2A, a graph 220 illustrates the PRB utilization and number of users/end devices 130 relating to normal conditions in the network, while in FIG. 2B, a graph 220 relates to when there is a low intensity event pertaining to the network, and in FIG. 2C, a graph 240 relates when there is a high intensity event in the network. According to this example, FIG. 2A depicts two clusters of data indicated by an “x” and a “Δ”. FIG. 2B indicates four clusters of data indicated by an “x”, a “Δ”, a “□”, and a “⋄.” FIG. 2C indicates eight clusters of data indicated by an “x”, a “Δ”, a “□”, a “⋄”, a “+”, an “∘”, a “*”, and a “ [symbol] .” According to this exemplary data, the event may pertain to a PRB utilization and/or number of users/end devices 130 (e.g., per network slice), and the event intensity may relate to their respective values, combination of values, and/or range of values associated with access devices/nodes 107. According to other exemplary scenarios, the event and event intensity may pertain to other types of data, as described herein.

According to an exemplary embodiment, the adaptive clustering sub-service may cluster various types of the data that enable evaluation of usage patterns associated with user traffic, PRB utilization (e.g., per network slice, per access device/node 107, per cell or antenna array, etc.), users per network slice, performance data (e.g., KPI, etc.), and so forth. Additionally, the adaptive clustering sub-service may cluster data in an adaptive manner based on the event, the event intensity, and modification of a hyperparameter value, as described herein.

Referring back to FIG. 1, according to an exemplary embodiment, network management device 125 may include a PRB prediction sub-service of the dynamic network slice re-balancing service, as described herein. The PRB prediction sub-service may include calculating a predicted PRB utilization for each access device 107 (and/or sub-component thereof) associated with each network slice. For example, an AI/ML model may be implemented as a neural network model, such as a Long Short-Term Memory (LSTM) neural network or another type of recurrent neural network (RNN) for example, and/or another type of model (e.g., a GLM, etc.).

According to an exemplary embodiment, the dynamic network slice re-balancing service may use an optimization algorithm, such as a reinforcement learning algorithm or another type of learning algorithm (e.g., a supervised learning algorithm, etc.) that will predict the PRB utilization for each access device 107 (or sub-component thereof) in relation to a network slice based on the output of the adaptive clustering sub-service. For example, the PRB prediction sub-service may use an enhanced reinforced neural network model to predict the PRB utilization for the classified access devices 107 or nodes and network slices, based on a prediction of PRB usage, events, event intensities, and/or other types of information (e.g., current and/or historical data of the data sub-service). In this way, the PRB prediction sub-service may efficiently and dynamically allocate PRBs for the network slice in a manner that optimizes radio spectrum usage while supporting associated traffic of end devices 130 using the network slice.

According to an exemplary embodiment, network management device 125 may include a re-balancing sub-service of the dynamic network slice re-balancing service, as described herein. The re-balancing sub-service may use the predicted PRB utilization to perform an operation of the re-balancing sub-service. The re-balancing sub-service may include determining whether or not to re-balance current PRB resources. For example, the re-balancing sub-service may compare the current PRB configuration to the predicted PRB utilization of the PRB prediction sub-service. Based on the result of the comparison, the re-balancing sub-service may determine whether to re-balance or adjust current PRB resources or not. For example, when the current PRB resources are the same or within a certain margin (e.g., threshold range either above or below) as the predicted PRB utilization, the re-balancing sub-service may determine to forego a re-balancing. Conversely, when the current PRB resources are not the same or not within a certain margin as the predicted PRB utilization, the re-balancing sub-service may determine to re-balance and generate a (new) PRB configuration.

FIG. 2D is a diagram illustrating an exemplary process 260 of the dynamic network slice re-balancing service according to an exemplary scenario. For example, referring to graph 1, the adaptive clustering sub-service may cluster radio sites A, B, C, etc., based on PRB utilization per network slice relative to time (e.g., time of day). That is, radio sites A, B, C, etc., may have similar PRB utilization patterns. In reference to graph 2, the PRB prediction sub-service may predict a PRB utilization for radio sites A, B, C, etc. According to an exemplary scenario, the PRB prediction sub-service may predict a PRB utilization that may be different than the current PRB utilization, as illustrated as a predicted PRB utilization per network slice 265. Additionally, according to this exemplary scenario, radio sites A, B, C, etc., may have a similar predicted PRB utilization. According to various exemplary embodiments, the adaptive clustering service may cluster radio sites based on PRB utilization, type of radio coverage area (e.g., residential, enterprise, city, rural, etc.), geography, per network slice, and/or another type of category or metric.

The PRB prediction sub-service may provide predicted PRB utilization per network slice 265 data to the re-balancing sub-service. The re-balancing sub-service may perform a discretization of the predicted PRB utilization per network slice 265 data, as illustrated in graph 3. For example, the re-balancing sub-service may perform a mean-binning procedure 270 of data 265 that may include discretization based on the mean of predicted PRB utilization over a certain time period. According to other examples, the re-balancing sub-service may perform a different type of discretization based on another type of statistical and/or arithmetic approach (e.g., median, mode, etc.).

Based on the differences between the current and predicted PRB utilization, the re-balancing sub-service may determine to re-balance, as described herein. When the re-balancing sub-service determines to re-balance, the re-balancing sub-service may determine the appropriate re-balancing. According to some exemplary embodiment, the selection of the re-balancing may be a binary choice. For example, the re-balancing sub-service may determine whether to decrease unused PRBs and move them to a reserve for PRBs or to increase the allocation of PRBs from the reserve to access device 107 and associated network slice. According to this exemplary scenario, the re-balancing sub-service may determine to increase the allocation of PRBs. The re-balancing sub-service may generate a PRB configuration that supports the discretized predicted PRB utilization.

The re-balancing sub-service may also notify network personnel when the reserve for PRBs is depleted or falls below a threshold value, for example. When the re-balancing sub-service determines to not re-balance, the re-balancing sub-service may permit the current PRB configuration to remain in effect until a subsequent evaluation may be performed, for example.

According to an exemplary embodiment, network management device 125 may include a PRB provisioning service of the dynamic network slice re-balancing service, as described herein. The PRB provisioning service may include autonomously provisioning in real-time the PRB configuration directed to access device 107 and the associated network slice based on the re-balancing sub-service. In this way, the dynamic network slice re-balancing service may manage and optimize radio spectrum utilization for access devices 107 and network slices of access network 105.

End device 130 may include a device that may have communication capabilities (e.g., wireless, wired, optical, etc.). End device 130 may or may not have computational capabilities. End device 130 may be implemented as a mobile device, a portable device, a stationary device (e.g., a non-mobile device and/or a non-portable device), a device operated by a user, or a device not operated by a user. For example, end device 130 may be implemented as a smartphone, a mobile phone, a personal digital assistant, a tablet, a netbook, a wearable device (e.g., a watch, glasses, headgear, a band, etc.), a computer, a gaming device, a television, a set top box, a music device, an IoT device, a drone, a smart device, an autonomous vehicle, or another type of wireless device (e.g., another type of user equipment (UE)). End device 130 may be configured to execute diverse types of software (e.g., applications, programs, etc.). The number and the types of software may vary among end devices 130. End device 130 may include “edge-aware” and/or “edge-unaware” application service clients. For purposes of description, end device 130 is not considered a network device. End device 130 may be implemented as a virtualized device in whole or in part.

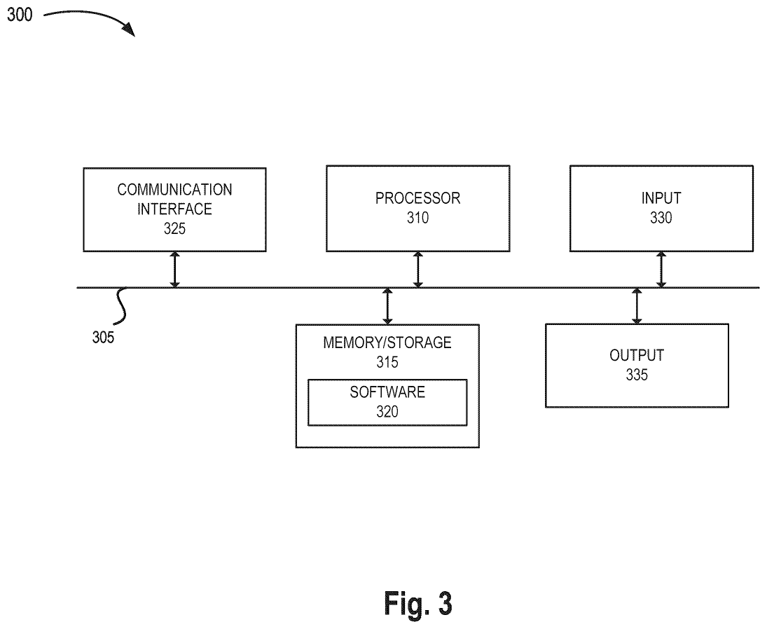

FIG. 3 is a diagram illustrating exemplary components of a device 300 that may be included in one or more of the devices described herein. For example, device 300 may correspond to access device 107, external device 117, core device 122, end device 130, and/or other types of devices, as described herein. As illustrated in FIG. 3, device 300 includes a bus 305, a processor 310, a memory/storage 315 that stores software 320, a communication interface 325, an input 330, and an output 335. According to other embodiments, device 300 may include fewer components, additional components, different components, and/or a different arrangement of components than those illustrated in FIG. 3 and described herein.

Bus 305 includes a path that permits communication among the components of device 300. For example, bus 305 may include a system bus, an address bus, a data bus, and/or a control bus. Bus 305 may also include bus drivers, bus arbiters, bus interfaces, clocks, and so forth.

Processor 310 includes one or multiple processors, microprocessors, data processors, co-processors, graphics processing units (GPUs), application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, neural processing unit (NPUs), and/or some other type of component that interprets and/or executes instructions and/or data. Processor 310 may be implemented as hardware (e.g., a microprocessor, etc.), a combination of hardware and software (e.g., a SoC, an ASIC, etc.), may include one or multiple memories (e.g., cache, etc.), etc.

Processor 310 may control the overall operation, or a portion of operation(s) performed by device 300. Processor 310 may perform one or multiple operations based on an operating system and/or various applications or computer programs (e.g., software 320). Processor 310 may access instructions from memory/storage 315, from other components of device 300, and/or from a source external to device 300 (e.g., a network, another device, etc.). Processor 310 may perform an operation and/or a process based on various techniques including, for example, multithreading, parallel processing, pipelining, interleaving, learning, model-based, etc.

Memory/storage 315 includes one or multiple memories and/or one or multiple other types of storage mediums. For example, memory/storage 315 may include one or multiple types of memories, such as, a random access memory (RAM), a dynamic RAM (DRAM), a static RAM (SRAM), a cache, a read only memory (ROM), a programmable ROM (PROM), an erasable PROM (EPROM), an electrically EPROM (EEPROM), a single in-line memory module (SIMM), a dual in-line memory module (DIMM), a flash memory (e.g., 2D, 3D, NOR, NAND, etc.), a solid state memory, and/or some other type of memory. Memory/storage 315 may include a hard disk (e.g., a magnetic disk, an optical disk, a magneto-optic disk, a solid-state component, etc.), a Micro-Electromechanical System (MEMS)-based storage medium, and/or a nanotechnology-based storage medium.

Memory/storage 315 may be external to and/or removable from device 300, such as, for example, a Universal Serial Bus (USB) memory stick, a dongle, a hard disk, mass storage, off-line storage, or some other type of storing medium. Memory/storage 315 may store data, software, and/or instructions related to the operation of device 300.

Software 320 includes an application or a program that provides a function and/or a process. As an example, with reference to network management device 125, software 320 may include an application that, when executed by processor 310, provides a function and/or a process of the dynamic network slice re-balancing service, as described herein. According to another example, with reference to end device 130, access device 107, and/or core device 122, software 320 may include an application that, when executed by processor 310, provides a function and/or a process of the dynamic network slice re-balancing service, as described herein. Software 320 may also include firmware, middleware, microcode, hardware description language (HDL), and/or another form of instruction. Software 320 may also be virtualized. Software 320 may further include an operating system (OS) (e.g., Windows, Linux, Android, proprietary, etc.).

Communication interface 325 permits device 300 to communicate with other devices, networks, systems, and/or the like. Communication interface 325 includes one or multiple wireless interfaces, optical interfaces, and/or wired interfaces. For example, communication interface 325 may include one or multiple transmitters and receivers, or transceivers. Communication interface 325 may operate according to a protocol stack and a communication standard.

Input 330 permits an input into device 300. For example, input 330 may include a keyboard, a mouse, a display, a touchscreen, a touchless screen, a button, a switch, an input port, speech recognition logic, and/or some other type of visual, auditory, tactile, affective, olfactory, etc., input component. Output 335 permits an output from device 300. For example, output 335 may include a speaker, a display, a touchscreen, a touchless screen, a light, an output port, and/or some other type of visual, auditory, tactile, etc., output component.

As previously described, a network device may be implemented according to various computing architectures (e.g., in a cloud, etc.) and according to various network architectures (e.g., a virtualized function, PaaS, etc.). Device 300 may be implemented in the same manner. For example, device 300 may be instantiated, created, deleted, or some other operational state during its life-cycle (e.g., refreshed, paused, suspended, rebooted, or another type of state or status), using well-known virtualization technologies. For example, access device 107, core device 122, external device 117, and/or another type of network device or end device 130, as described herein, may be a virtualized device.

Device 300 may be configured to perform a process and/or a function, as described herein, in response to processor 310 executing software 320 stored by memory/storage 315. By way of example, instructions may be read into memory/storage 315 from another memory/storage 315 (not shown) or read from another device (not shown) via communication interface 325. The instructions stored by memory/storage 315 may configure device 300 and/or cause processor 310 to perform a function or a process described herein. Alternatively, for example, according to other implementations, device 300 may be configured to perform a function or a process described herein based on the execution of hardware (processor 310, etc.).

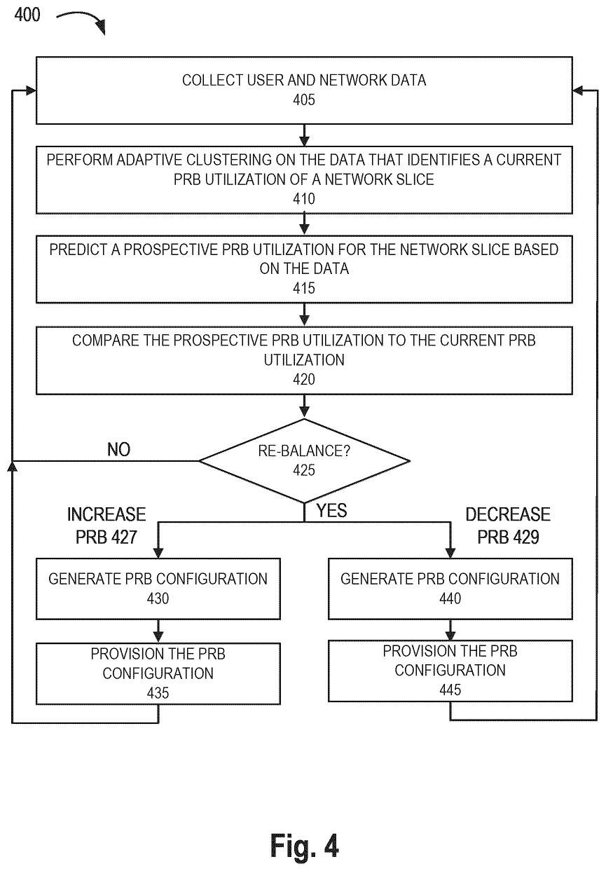

FIG. 4 is a flow diagram illustrating another exemplary process 400 of an exemplary embodiment of the dynamic network slice re-balancing service. According to an exemplary embodiment, network management device 125 may perform a step of process 400. According to another exemplary embodiment, network management device 125 and one or multiple other network devices (e.g., access device 107, external device 117, core device 122, etc.), may collaboratively perform a step of process 400. According to an exemplary implementation, processor 310 executes software 320 to perform a step (in whole or in part) of process 400, as described herein. Alternatively, a step (in whole or in part) may be performed by execution of only hardware. For purposes of description, the steps are described as exemplarily performed by network management device 125.

In block 405, network management device 125 may collect user and network data. For example, network management device 125 may obtain customer-to-network association data and network-to-event association data from various sources, as described herein.

In block 410, network management device 125 may perform adaptive clustering on the data that identifies a current PRB utilization of a network slice. For example, network management device 125 may use an adaptive BIRCH algorithm, which includes an adjustable hyperparameter based on an event intensity indicated in the data, to cluster the data. Network management device 125 may perform multiple iterations of clustering in relation to different types of the data (e.g., performance data, PRB utilization, etc.), as described herein. Network management device 125 may generate clustered data pertaining to access devices/nodes 107 in relation to PRB utilizations and network slices, as described herein.

In block 415, network management device 125 may predict a prospective PRB utilization for the network slice based on the data. For example, based on the output of the adaptive clustering sub-service, network management device 125 may apply an AI/ML model (e.g., a NNM, etc.) and an optimization algorithm (e.g., reinforced learning algorithm, etc.) that predicts prospective PRB utilizations for access devices/nodes 107 and network slices, as described herein. Network management device 125 may also use current and historical data from the data sub-service.

In block 420, network management device 125 may compare the prospective PRB utilization to the current PRB utilization. For example, network management device 125 may compare prospective and current PRB utilizations of access device/node 107 and a network slice.

In block 425, network management device 125 may determine whether or not to perform a re-balancing of PRB resources. For example, based on the result of the comparison, network management device 125 may determine whether the PRB utilizations are the same or within a certain margin in which re-balancing is not performed, or different to a degree in which re-balancing is to be performed, as described herein.

When network management device 125 determines that a re-balance is not to be performed (block 425-NO), process 400 may continue to block 405. For example, network management device 125 may not adjust the current PRB configuration. Network management device 125 may begin another iteration of the dynamic network slice re-balancing process.

When network management device 125 determines that a re-balance is to be performed (block 425-YES), network management device 125 may increase PRB 427 or decrease PRB 429, as described herein.

In block 430, when the PRB allocation is to be increased, network management device 125 may generate a PRB configuration that increases PRB allocation. For example, network management device 125 may generate a PRB configuration that uses PRBs (e.g., currently allocated in a PRB reserve) to increase the PRB allocation in the PRB configuration relative to the current PRB allocation and configuration. According to various exemplary embodiments, the PRB configuration may include a total number of PRBs for access device/node 107 (or sub-component thereof) and the network slices, a maximum number of PRBs for each network slice, or a combination of both. For example, the PRB configuration may increase the total number of PRBs from 800 to 1000 or some other numerical increase of PRBs. Additionally, or alternatively, the PRB configuration may allocate 200 PRBs to network slice 1, 300 PRBs to network slice 2, 150 PRBs to network slice 3, and 350 PRBs to network slice 4. According to still other exemplary embodiments, the PRB configuration may include time period data. For example, the time period data may change the allocation of PRBs for a network slice based on busy versus non-busy time periods. By way of example, the allocation of 350 PRBs for network slice may for a time period between 7:00 am-9:00 am and 3:30 pm-6:00 pm, but 250 PRBs during other time periods. During the other time periods, the 100 PRBs may be allocated to a reserve pool of PRBs at access device/node 107, for example. According to some exemplary embodiments, network slice 4 may have priority to the 100 PRBs in the reserve pool relative to the other network slices, such as network slice 1, 2, and 3. According to various exemplary embodiments, network management device 125 may generate the PRB configuration based on other factors, such as frequency band, RU/DU components at access device/node 107, and the like.

In block 435, network management device 125 may provision the PRB configuration. For example, network management device 125 may transmit the PRB configuration to access devices/nodes 107. Network management device 125 may perform or execute a configuration update.

In block 440, when PRB is decreased, network management device 125 may generate a PRB configuration that decreases PRB allocation. For example, network management device 125 may generate a PRB configuration that decreases PRBs (e.g., allocates PRBs to a PRB reserve) to decrease the PRB allocation in the PRB configuration relative to the current PRB allocation and configuration. According to various exemplary embodiments, the PRB configuration may include a total number of PRBs for access device/node 107 (or sub-component thereof) and the network slices, a maximum number of PRBs for each network slice, a combination of both, include time period data, and so forth, as described herein.

In block 445, network management device 125 may provision the PRB configuration. For example, network management device 125 may transmit the PRB configuration to access devices/nodes 107. Network management device 125 may perform or execute a configuration update.

As further illustrated, after performing block 435 or block 445, process 400 may continue to block 405 in which network management device 125 may begin another iteration of the dynamic network slice re-balancing process.

FIG. 4 illustrates an exemplary process 400 of the dynamic network slice re-balancing service, however, according to other exemplary embodiments, the dynamic network slice re-balancing service may perform additional operations, fewer operations, and/or different operations than those illustrated and described in relation to FIG. 4. For example, network management device 125 may notify network personnel when the PRB reserve is below a threshold value, as described herein.

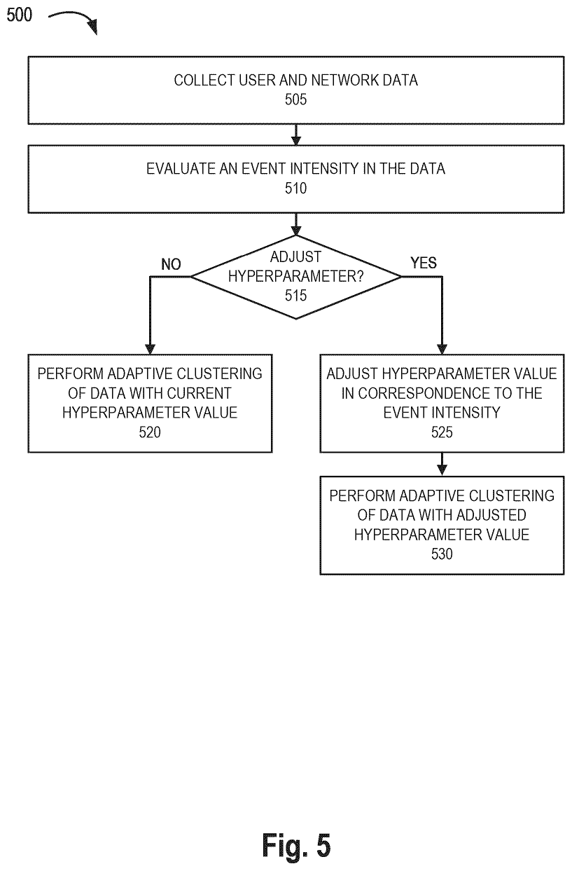

FIG. 5 is a flow diagram illustrating another exemplary process 500 of an exemplary embodiment of the dynamic network slice re-balancing service. According to an exemplary embodiment, network management device 125 may perform a step of process 500. According to another exemplary embodiment, network management device 125 and one or multiple other network devices (e.g., access device 107, external device 117, core device 122, etc.), may collaboratively perform a step of process 500. According to an exemplary implementation, processor 310 executes software 320 to perform a step (in whole or in part) of process 500, as described herein. Alternatively, a step (in whole or in part) may be performed by execution of only hardware. For purposes of description, the steps are described as exemplarily performed by network management device 125.

In block 505, network management device 125 may collect user and network data. For example, network management device 125 may obtain customer-to-network association data and network-to-event association data from various sources, as described herein.

In block 510, network management device 125 may evaluate an event intensity in the data. For example, network management device 125 may evaluate the event intensity relative to an adjustable hyperparameter value of the adaptive clustering algorithm. According to some exemplary embodiments, the adjustable hyperparameter may relate to a threshold for cluster merging, the number of clusters, the max number of data points in a sub-cluster, or another hyperparameter that effects a clustering feature and/or a clustering feature tree. According to an exemplary embodiment, the event and the event intensity may relate to data of the data sub-service. For example, the event may relate to a type of data (e.g., a KPI of the performance data or another type of data) and its value, a combination of different types of data and their values, and/or a range of values associated with a type of data or multiple types of data associated with access device/node 107.

According to an exemplary embodiment, network management device 125 may compare an event (e.g., download speed, upload speed, PRB utilization at access device 107, Number of Users of a network slice, etc.) and event value (e.g., download speed value, upload speed value, PRB utilization value, number of users value), which may be included in the data, to a corresponding threshold event and threshold event value. According to various exemplary embodiments, network management device 125 may store multiple types of events and multiple levels of event threshold values. According to an exemplary embodiment, threshold events and threshold event values may be correlated to hyperparameters and hyperparameter values, as described herein. In this way, network management device 125 may determine a prospective hyperparameter value based on the comparison of the event and event value to the threshold event and the threshold event value.

In block 515, network management device 125 may determine whether to adjust a hyperparameter value. For example, network management device 125 may compare a current hyperparameter value to the prospective hyperparameter value. Based on the result of the comparison, network management device 125 may determine to adjust or not adjust the hyperparameter value. For example, when the current and the prospective hyperparameter values are the same, network management device 125 may determine to not adjust the hyperparameter value. However, when the current and the prospective hyperparameter values are not the same, network management device 125 may determine to adjust the hyperparameter value.

When network management device 125 determines to not adjust the hyperparameter (block 515-NO), network management device 125 may perform adaptive clustering of the data with a current hyperparameter value (block 520). For example, network management device 125 may cluster several types of data, which may include PRB utilization associated with a network slice and access device/node 107, as described herein.

When network management device 125 determines to adjust the hyperparameter (block 515-YES), network management device 125 may adjust the hyperparameter value in correspondence to the event intensity (block 525). For example, network management device 125 may increase or decrease the hyperparameter value based on the correlated threshold event value. Depending on the adjustment, the hyperparameter value may contribute to the: increase or decrease of the number of clusters; increase or decrease of the threshold for cluster merging; increase or decrease of the maximum number of data points in a sub-cluster; and so forth, as described herein.

In block 530, network management device 125 may perform adaptive clustering of the data with the adjusted hyperparameter value. For example, network management device 125 may cluster several types of data, which may include PRB utilization associated with a network slice and access device/node 107, as described herein.

FIG. 5 illustrates an exemplary process 500 of the dynamic network slice re-balancing service, however, according to other exemplary embodiments, the dynamic network slice re-balancing service may perform additional operations, fewer operations, and/or different operations than those illustrated and described in relation to FIG. 5. For example, network management device 125 may account for the event intensity when calculating the predicted PRB utilization, as described herein.

As set forth in this description and illustrated by the drawings, reference is made to “an exemplary embodiment,” “exemplary embodiments,” “an embodiment,” “embodiments,” etc., which may include a particular feature, structure, or characteristic in connection with an embodiment(s). However, the use of the phrase or term “an embodiment,” “embodiments,” etc., in various places in the description does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

In addition, while series of blocks have been described regarding the processes illustrated in FIGS. 4 and 5, the order of the blocks may be modified according to other embodiments. Further, non-dependent blocks may be performed in parallel. Additionally, other processes described in this description may be modified and/or non-dependent operations may be performed in parallel.

Embodiments described herein may be implemented in many different forms of software executed by hardware. For example, a process or a function may be implemented as “logic,” a “component,” or an “element.” The logic, the component, or the element, may include, for example, hardware (e.g., processor 310, etc.), or a combination of hardware and software (e.g., software 320).

Embodiments have been described without reference to the specific software code because the software code can be designed to implement the embodiments based on the description herein and commercially available software design environments and/or languages. For example, diverse types of programming languages including, for example, a compiled language, an interpreted language, a declarative language, or a procedural language may be implemented.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

Additionally, embodiments described herein may be implemented as a non-transitory computer-readable storage medium that stores data and/or information, such as instructions, program code, a data structure, a program module, an application, a script, or other known or conventional form suitable for use in a computing environment. The program code, instructions, application, etc., is readable and executable by a processor (e.g., processor 310) of a device. A non-transitory storage medium includes one or more of the storage mediums described in relation to memory/storage 315. The non-transitory computer-readable storage medium may be implemented in a centralized, distributed, or logical division that may include a single physical memory device or multiple physical memory devices spread across one or multiple network devices.

To the extent the aforementioned embodiments collect, store, or employ personal information of individuals, it should be understood that such information shall be collected, stored, and used in accordance with all applicable laws concerning protection of personal information. Additionally, the collection, storage and use of such information can be subject to the consent of the individual to such activity, for example, through well known “opt-in” or “opt-out” processes as can be appropriate for the situation and type of information. Collection, storage, and use of personal information can be in an appropriately secure manner reflective of the type of information, for example, through various encryption and anonymization techniques for particularly sensitive information.

No element, act, or instruction set forth in this description should be construed as critical or essential to the embodiments described herein unless explicitly indicated as such.

All structural and functional equivalents to the elements of the various aspects set forth in this disclosure that are known or later come to be known are expressly incorporated herein by reference and are intended to be encompassed by the claims.

What is claimed is:

1. A method comprising:
receiving, by a network device, data;
performing, by the network device, adaptive clustering of the data, which includes classifying access devices of a radio access network based on current physical resource block (PRB) utilization data of a network slice, wherein an adaptive clustering algorithm includes a hyperparameter that has an adjustable value based on the data;
generating, by the network device based on the performing, prospective PRB utilization data of the network slice; and
determining, by the network device based on a comparison of the current PRB utilization data and the prospective PRB utilization data, whether to adjust a current PRB configuration.

2. The method of claim 1, further comprising:
generating, by the network device, a prospective PRB configuration, which differs from the current PRB configuration, based on the prospective PRB utilization data; and
provisioning, by the network device, the prospective PRB configuration at one or more of the access devices.

3. The method of claim 2, wherein the prospective PRB configuration includes a decrease in PRB allocation or an increase in PRB allocation.

4. The method of claim 1, wherein the data includes sporting and musical event information, weather and disaster information, network outage information, and network degradation information.

5. The method of claim 1, further comprising:
evaluating, by the network device based on a threshold value associated with an event, one or more instances of the data for an event intensity; and
determining, by network device based on the evaluating, whether to modify the adjustable value of the hyperparameter.

6. The method of claim 1, wherein the adaptive clustering algorithm is an adaptive Balanced Iterative Reducing and Clustering using Hierarchies (BIRCH) clustering algorithm.

7. The method of claim 1, further comprising:
determining, by the network device based on the comparison, to adjust the current PRB configuration; and
converting, by the network device, the prospective PRB utilization data using a mean discretization procedure.

8. The method of claim 1, wherein the prospective PRB utilization data is further generated based on historical data and a reinforced neural network model.

9. A network device comprising:
a processor, wherein the processor is configured to:
receive data;
perform adaptive clustering of the data, which includes classifying access devices of a radio access network based on current physical resource block (PRB) utilization data of a network slice, wherein an adaptive clustering algorithm includes a hyperparameter that has an adjustable value based on the data;
generate, based on the adaptive clustering, prospective PRB utilization data of the network slice; and
determine, based on a comparison of the current PRB utilization data and the prospective PRB utilization data, whether to adjust a current PRB configuration.

10. The network device of claim 9, wherein the processor is further configured to:
generate a prospective PRB configuration, which differs from the current PRB configuration, based on the prospective PRB utilization data; and
provision the prospective PRB configuration at one or more of the access devices.

11. The network device of claim 10, wherein the prospective PRB configuration includes a decrease in PRB allocation or an increase in PRB allocation.

12. The network device of claim 9, wherein the processor is further configured to:
evaluate, based on a threshold value associated with an event, one or more instances of the data for an event intensity; and
determine, based on the evaluation, whether to modify the adjustable value of the hyperparameter.

13. The network device of claim 9, wherein the data includes sporting and musical event information, weather and disaster information, network outage information, and network degradation information.

14. The network device of claim 9, wherein the adaptive clustering algorithm is an adaptive Balanced Iterative Reducing and Clustering using Hierarchies (BIRCH) clustering algorithm.

15. The network device of claim 9, wherein the processor is further configured to:
determine, based on the comparison, to adjust the current PRB configuration; and
convert the prospective PRB utilization data using a mean discretization procedure.

16. The network device of claim 9, wherein the prospective PRB utilization data is further generated based on historical data and a reinforced neural network model.

17. A non-transitory computer-readable storage medium storing instructions executable by a processor of a network device, wherein the instructions are configured to:
receive data;
perform adaptive clustering of the data, which includes classifying access devices of a radio access network based on current physical resource block (PRB) utilization data of a network slice, wherein an adaptive clustering algorithm includes a hyperparameter that has an adjustable value based on the data;
generate, based on the adaptive clustering, prospective PRB utilization data of the network slice; and
determine, based on a comparison of the current PRB utilization data and the prospective PRB utilization data, whether to adjust a current PRB configuration.

18. The non-transitory computer-readable storage medium of claim 17, wherein the instructions are further configured to:
generate a prospective PRB configuration, which differs from the current PRB configuration, based on the prospective PRB utilization data; and
provision the prospective PRB configuration at one or more of the access devices.

19. The non-transitory computer-readable storage medium of claim 18, wherein the prospective PRB configuration includes a decrease in PRB allocation or an increase in PRB allocation.

20. The non-transitory computer-readable storage medium of claim 17, wherein the instructions are further configured to:
evaluate, based on a threshold value associated with an event, one or more instances of the data for an event intensity; and
determine, based on the evaluation, whether to modify the adjustable value of the hyperparameter.
